(19) United States
(12) Patent Application Publication
(10) Pub. No.: US 2026/0062515 A1
(43) Pub. Date: Mar. 5, 2026

(54) PHOTOSENSITIVE RESIN COMPOSITION, PHOTOSENSITIVE RESIN LAYER, AND SEMICONDUCTOR DEVICE USING THE SAME

(71) Applicant: SAMSUNG SDI CO., LTD., Yongin-si (KR)

(72) Inventors: Hokyun RYU, Suwon-si (KR); Sang Soo KIM, Suwon-si (KR); Taek-Jin BAEK, Suwon-si (KR); Heekyoung KANG, Suwon-si (KR); Mingyum KIM, Suwon-si (KR); Jinhee KANG, Suwon-si (KR); Byeongwook PARK, Suwon-si (KR); Chungbeum HONG, Suwon-si (KR)

(21) Appl. No.: 19/319,478

(22) Filed: Sep. 4, 2025

(30) Foreign Application Priority Data
Sep. 4, 2024 (KR) 10-2024-0120374

(51) Int. Cl. C08G 73/10; C08K 5/3417

(52) U.S. Cl. CPC C08G 73/1075; C08G 73/1025; C08K 5/3417

(57) ABSTRACT

A photosensitive resin composition including a polyimide resin represented by Chemical Formula 1; a photopolymerizable compound; a photopolymerization initiator; and a solvent, a photosensitive resin layer manufactured utilizing the photosensitive resin composition, and a semiconductor device including the photosensitive resin layer are disclosed.

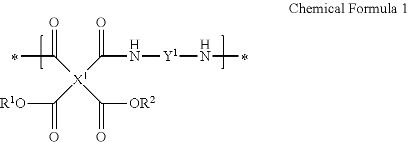

### CROSS-REFERENCE TO RELATED APPLICATION

The present application claims priority to and the benefit of Korean Patent Application No. 10-2024-0120374, filed on Sep. 4, 2024, in the Korean Intellectual Property Office, the entire content of which is incorporated herein by reference.

### BACKGROUND

### 1. Field

One or more embodiments of the present disclosure relate to a photosensitive resin composition, a photosensitive resin layer utilizing the photosensitive resin composition, and a semiconductor device.

### 2. Description of the Related Art

With the advent of an era of hyper-connected intelligence era—driven by technologies, such as artificial intelligence (AI), big data, Internet-of-Things (IoT), autonomous vehicles (self-driving cars), remote medical services (treatments), and/or the like—the development of various electronic devices, including smartphones, is accelerating.

Accordingly, fifth-generation (5G) communication technology, which enables ultra-high-speed and high-capacity wireless data transmission, has become increasingly important. The market for communication component materials and elements used in devices, such as smartphones, is expected to grow significantly, reaching approximately US$2.3 billion (about 14,000 tons per year) between 2020 and 2026. In 5G communication, particularly, in the Sub-6 GHz and 28 GHz frequency bands, dielectric substrates are required or desired to have a low dielectric constant (Dk) and a low dielectric loss factor (Df) to minimize or reduce propagation loss. However, comparable polyimide (PI), which has been used in 4G LTE communication, does not adequately or suitably meet these requirements.

It was expected that modified polyimide (MPI) may replace liquid crystal polymer (LCP) as the mainstream antenna material for newer phone models. This prediction was based on the fact that flexible copper clad laminate (FCCL) manufacturing processes were already established utilizing PI film. Because modifying existing production lines to accommodate LCP would require significant investment, module manufacturers preferred or desired to continue utilizing PI-based processes. Consequently, MPI has been actively developed as a material that may be processed utilizing existing equipment while addressing the limitations of LCP.

Accordingly, there is a growing need or desire for the development of polyimide precursor resins that exhibit both (e.g., simultaneously) low dielectric constant (Dk) and low dielectric loss factor (Df) to meet the performance demands of next-generation communication technologies.

### SUMMARY

One or more aspects of embodiments of the present disclosure are directed toward a photosensitive resin composition having low dielectric constant (Dk) and dielectric loss factor (Df), as well as excellent or suitable elongation and reliability.

One or more aspects of embodiments of the present disclosure are directed toward a photosensitive resin layer manufactured utilizing the photosensitive resin composition.

One or more aspects of embodiments of the present disclosure are directed toward a semiconductor device including the photosensitive resin layer.

Additional aspects of embodiments will be set forth in part in the description which follows and, in part, will be apparent from the description or may be learned by practice of the presented embodiments of the disclosure.

According to one or more embodiments of the present disclosure, a photosensitive resin composition includes a polyimide resin represented by Chemical Formula 1; a photopolymerizable compound; a photopolymerization initiator; and a solvent.

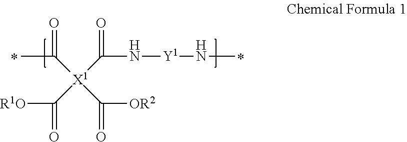

In Chemical Formula 1,
R¹ and R² are each independently a substituted or unsubstituted C1 to C20 alkyl group, a substituted or unsubstituted C3 to C20 cycloalkyl group, a substituted or unsubstituted C6 to C20 aryl group, or a substituted or unsubstituted C2 to C20 heterocyclic group,
X¹ is represented by Chemical Formula 2,

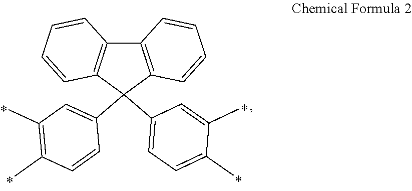

Y¹ is represented by Chemical Formula 3,

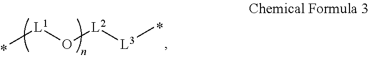

wherein, in Chemical Formula 3,
L¹ to L³ are each independently a substituted or unsubstituted C1 to C20 alkylene group or a substituted or unsubstituted C6 to C20 arylene group, and
n is an integer of 0 to 10.

R¹ and R² may each independently be represented by Chemical Formula R.

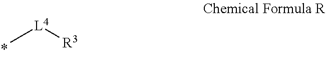

In Chemical Formula R,
R³ may be a (meth)acrylate group, and
L⁴ may be a substituted or unsubstituted C1 to C20 alkylene group.

The polyimide resin may include a functional group represented by Chemical Formula S at least one of both terminal ends.

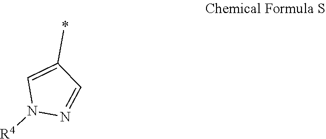

In Chemical Formula S,
R⁴ may be a hydrogen atom or a substituted or unsubstituted C1 to C20 alkyl group.

In Chemical Formula 1, n may be an integer of 0 to 2.

In Chemical Formula 1, Y¹ may be a C1 to C20 alkylene group unsubstituted or substituted with an alkyl group.

In Chemical Formula 1, Y¹ may be unsubstituted C6 to C20 alkylene group.

The photosensitive resin composition may include the photopolymerizable compound in an amount of about 5 parts to about 20 parts by weight, the photopolymerization initiator in an amount of about 3 parts by weight to about 10 parts by weight, and the solvent in an amount of about 100 parts to about 500 parts by weight, based on 100 parts by weight of the polyimide resin.

The photosensitive resin composition may further include a photosensitizer, a radical scavenger, a silane-based coupling agent, an organic acid, or a (e.g., any suitable) combination thereof.

The photosensitive resin composition may be a negative type (kind) photosensitive resin composition.

One or more embodiments of the present disclosure provide a photosensitive resin layer manufactured utilizing the photosensitive resin composition as described in one or more embodiments.

The photosensitive resin layer may be a semiconductor redistribution layer insulation (e.g., electrical insulation) layer.

One or more embodiments of the present disclosure provide a semiconductor device including the photosensitive resin layer as described in one or more embodiments.

Other embodiments of the present disclosure are included in the following detailed description.

The photosensitive resin composition according to one or more embodiments may reduce dielectric constant (Dk) and dielectric loss factor (Df) as well as improve or enhance elongation and reliability by including a polyimide resin having a specific (e.g., set or predetermined) structure. For example, these performance enhancements may be attributed to the inclusion of the polyimide resin, as described in Chemical Formula 1. The structural features of the polyimide resin, including the nature of the substituents R¹ and R², the linking groups X¹ and Y¹, and the terminal functional groups represented by Chemical Formula S, may contribute to the electrical and mechanical performance of the composition.

Also, the photosensitive resin composition may include a photopolymerizable compound, a photopolymerization initiator, and a solvent in specific (e.g., set or predetermined) weight ratios relative to the polyimide resin, as disclosed herein. These components may be selected and formulated to ensure compatibility with photosensitive processing and to maintain the desired dielectric and mechanical properties after curing. The composition may also optionally include additives, such as a photosensitizer, a radical scavenger, a silane-based coupling agent, or an organic acid to further enhance performance characteristics. As a result, the composition may be suitable to form a photosensitive resin layer that may be utilized in semiconductor devices requiring or desiring low Dk and Df, along with high elongation and reliability.

### DETAILED DESCRIPTION

Hereinafter, the subject matter of the present disclosure will be described in more detail. However, these embodiments are provided as examples, and embodiments of the present disclosure are not limited thereto.

The utilization of “may” if (e.g., when) describing embodiments of the present disclosure refers to “one or more embodiments of the present disclosure.”

In the context of the present application and unless otherwise defined, the terms “use,” “using,” and “used” may be considered synonymous with the terms “utilize,” “utilizing,” and “utilized,” respectively.

As used herein, the singular forms “a,” “an,” and “the” are intended to include the plural forms as well, unless the context clearly indicates otherwise. The singular expression includes the plural expression unless the context clearly dictates otherwise.

As used herein, the term “and/or” or “or” includes any and all combinations of one or more of the associated listed items.

Throughout the present disclosure, the expressions, such as “at least one of,” “one of,” and “selected from,” if (e.g., when) preceding a list of elements, modify the entire list of elements and do not modify the individual elements of the list. For example, “at least one of a, b, or c,” “at least one selected from among a, b, and c,” “at least one selected from among a to c,” and/or the like indicates only a, only b, only c, both (e.g., simultaneously) a and b, both (e.g., simultaneously) a and c, both (e.g., simultaneously) b and c, all of a, b, and c, or variations thereof.

As used herein, “combination thereof” may refer to a mixture, a stack, a composite, a copolymer, an alloy, a blend, a reaction product, and/or the like of constituents.

In the present disclosure, it will be understood that the term “comprise(s)/comprising,” “include(s)/including,” or “have/has/having” specifies the presence of stated features, integers, steps, operations, elements, and/or components, but do not preclude the presence or addition of one or more other features, integers, steps, operations, elements, components, and/or groups thereof. Also, the terms “comprise(s)/comprising,” “include(s)/including,” “have/has/having” or similar terms include or support the terms “consisting of” and “consisting essentially of,” indicating the presence of stated features, integers, steps, operations, elements, and/or components, without or essentially without the presence of other features, integers, steps, operations, elements, components, and/or groups thereof.

As utilized herein, the terms “substantially,” “about,” or similar terms are used as terms of approximation and not as terms of degree and are intended to account for the inherent deviations in measured or calculated values that would be recognized by those of ordinary skill in the art. “About” as used herein is inclusive of the stated value and refers to as being within an acceptable range of deviation for the particular value as determined by one of ordinary skill in the art, considering the measurement in question and the error associated with measurement of the particular quantity (e.g., the limitations of the measurement system). For example, “about” may refer to as being within one or more standard deviations or within ±30%, ±20%, ±10%, or ±5% of the stated value. Also, it should be understood that, even if (e.g., when) the terms “about,” “approximately,” or “substantially” are not expressly recited in a given element (e.g., a claim element), the scope of such element is intended to include variations that are insubstantial or within the understanding of one of ordinary skill in the art. For example, numerical values and ranges provided herein are intended to include tolerances and measurement uncertainties that would be recognized by those skilled in the art, and the elements (e.g., claim elements) should be construed accordingly to encompass such equivalents.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, for example, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in the present disclosure is intended to include all higher numerical limitations subsumed therein. Accordingly, Applicant reserves the right to amend the disclosure, including the claims, to expressly recite any sub-range subsumed within the ranges expressly recited herein.

As used herein, if (e.g., when) specific definition is not otherwise provided, “alkyl group” refers to a C1 to C20 alkyl group, “alkenyl group” refers to a C2 to C20 alkenyl group, “cycloalkenyl group” refers to a C3 to C20 cycloalkenyl group, “heterocycloalkenyl group” refers to a C3 to C20 heterocycloalkenyl group, “aryl group” refers to a C6 to C20 aryl group, “arylalkyl group” refers to a C7 to C20 arylalkyl group, “alkylene group” refers to a C1 to C20 alkylene group, “arylene group” refers to a C6 to C20 arylene group, “alkylarylene group” refers to a C7 to C20 alkylarylene group, “heteroarylene group” refers to a C3 to C20 heteroarylene group, and “alkoxylene group” refers to a C1 to C20 alkoxylene group.

As used herein, if (e.g., when) specific definition is not otherwise provided, “substituted” refers to replacement of at least one hydrogen of a compound by a substituent selected from among a halogen atom (F, Cl, Br, or I), a C1 to C20 alkyl group substituted with a halogen atom, such as a trifluoromethyl group, a hydroxyl group, a C1 to C20 alkoxy group, a nitro group, a cyano group, an amine group, an imino group, an azido group, an amidino group, a hydrazino group, a hydrazono group, a carbonyl group, a carbamyl group, a thiol group, an ester group, an ether group, a carboxyl group or a salt thereof, a sulfonic acid group or a salt thereof, a phosphoric acid or a salt thereof, a C1 to C20 alkyl group, a C2 to C20 alkenyl group, a C2 to C20 alkynyl group, a C6 to C20 aryl group, a C3 to C20 cycloalkyl group, a C3 to C20 cycloalkenyl group, a C3 to C20 cycloalkynyl group, a C2 to C20 heterocycloalkyl group, a C2 to C20 heterocycloalkenyl group, a C2 to C20 heterocycloalkynyl group, a C3 to C20 heteroaryl group, a (meth)acrylate group, or a (e.g., any suitable) combination thereof.

As used herein, if (e.g., when) specific definition is not otherwise provided, “hetero” refers to inclusion of at least one heteroatom selected from among N, O, S, and P, in the chemical formula.

As used herein, if (e.g., when) specific definition is not otherwise provided, “(meth)acrylate” refers to both (e.g., simultaneously) “acrylate” and “methacrylate.”

As used herein, if (e.g., when) a definition is not otherwise provided, the term “combination” refers to mixing or copolymerization. Also, “copolymerization” refers to block copolymerization, alternating copolymerization, or random copolymerization, and “copolymer” refers to a block copolymer, an alternating copolymer, or a random copolymer.

As used herein, if (e.g., when) specific definition is not otherwise provided, an unsaturated bond includes not only multiple bonds between carbon and carbon atoms, but also those containing other molecules, such as a carbonyl bond and an azo bond.

In the chemical formula of the present disclosure, unless a specific definition is otherwise provided, a hydrogen atom is bonded at the position if (e.g., when) a chemical bond is not drawn where supposed to be given.

As used herein, if (e.g., when) a definition is not otherwise provided, “*” refers to a linking part between the same or different atoms, or chemical formulas.

As a market for wafer level packaging (WLP) and panel level packaging (PLP) grows, a photosensitive material for a redistribution layer (RDL) is increasingly utilized. As the photosensitive material, a photosensitive polyimide resin, a photosensitive benzocyclobutene (BCB) resin, a photosensitive phenol resin, and/or the like are currently utilized, and the photosensitive polyimide resin, which is able to satisfy both (e.g., simultaneously) processability and reliability, is mainly or predominantly utilized.

In contrast, as the redistribution layer becomes multi-layered and performs high-speed processing, because high-frequency signals are likely to be lost, a design to reduce the dielectric loss (e.g., a degree or occurrence of the dielectric loss) of the package material is needed or desired.

One or more embodiments of the present disclosure relate to a photosensitive resin composition, a photosensitive resin layer formed by utilizing the photosensitive resin composition, and a semiconductor device including the photosensitive resin layer.

Recently, as electronic devices have been trending toward miniaturization, a high speed, and one or more suitable functions, a signal transmission speed within the electronic devices or with the outside of the electronic devices is increasing. Accordingly, a printed circuit board (PCB) utilizing an insulator (e.g., an electrical insulator) with a much lower dielectric constant and dielectric loss coefficient than an insulator that is generally available or generally used is required or desired.

One or more technologies that are generally available are to reduce a dielectric loss by a method of improving or optimizing an adhesive layer, a stacking structure, and/or the like of a flexible printed circuit substrate, but this method has structural limitations and needs or is desired to control characteristics of each component. Recently, a liquid crystal polymer (LCP), an insulator (e.g., an electrical insulator) having a lower dielectric constant and less affected by moisture absorption than polyimide that is generally used, has been applied even to the flexible printed circuit substrate. However, even if (e.g., when) LCP is applied, because LCP has no significantly or substantially superior dielectric constant (Dk=2.9) to the dielectric constant (Dk=3.2) of the polyimide and substantially low heat resistance as to be a problem in a soldering process, the effect of its application may be minimal, and in addition, because LCP is a thermoplastic material, which may have low compatibility with a PCB manufacturing process of utilizing the polyimide that is generally used, which utilizes a laser in processing a via hole. Accordingly, as a solution to this, efforts are being made to reduce the dielectric constant of the polyimide utilized as an insulator (e.g., an electrical insulator) of the flexible printed circuit substrate that is generally used. For example, comparable approaches to reducing dielectric loss in flexible printed circuit substrates have typically focused on optimizing the adhesive layer, stacking structure, or similar design elements. However, these methods face inherent structural limitations and require precise control over the properties of each component. More recently, liquid crystal polymer (LCP) has been introduced as an insulating (e.g., electrically insulating) material due to its relatively low dielectric constant and reduced sensitivity to moisture absorption compared to comparable polyimide. Despite these advantages, LCP may offer only a marginal improvement or enhancement in dielectric constant (Dk=2.9) over polyimide (Dk=3.2), and its low heat resistance poses challenges during soldering processes. Also, as a thermoplastic, LCP is often incompatible with standard printed circuit board (PCB) manufacturing processes that rely on laser drilling, which are designed for thermosetting polyimide materials. In light of these limitations, efforts have shifted toward reducing the dielectric constant of polyimide itself, which remains the dominant insulating (e.g., electrically insulating) material in flexible printed circuit substrates.

One or more embodiments of the present disclosure provide a photosensitive resin composition capable of reducing a dielectric constant and a dielectric loss through structural modification of a polyimide resin and improving or enhancing elongation and reliability. As the redistribution layer becomes multi-layered and performs a high-speed process, because high frequency signals are more likely to be lost, a design to reduce a dielectric loss of a package material is desired or required, and accordingly, the dielectric loss (e.g., a degree or occurrence of the dielectric loss) may be reduced by modifying the polyimide resin into a structure represented by Chemical Formula 1 according to the present disclosure.

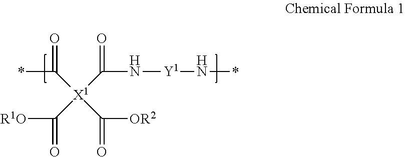

In Chemical Formula 1,
R¹ and R² may each independently be a substituted or unsubstituted C1 to C20 alkyl group, a substituted or unsubstituted C3 to C20 cycloalkyl group, a substituted or unsubstituted C6 to C20 aryl group, or a substituted or unsubstituted C2 to C20 heterocyclic group, and
X¹ may be represented by Chemical Formula 2,

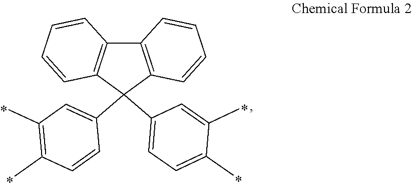

Y¹ may be represented by Chemical Formula 3,

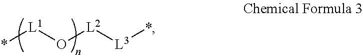

wherein, in Chemical Formula 3,
L¹ to L³ may each independently be a substituted or unsubstituted C1 to C20 alkylene group or a substituted or unsubstituted C6 to C20 arylene group, and
n may be an integer of 0 to 10.

Hereinafter, each component is described in more detail.

### (A) Resin

By controlling or selecting the structure of the polyimide resin as in Chemical Formula 1, both (e.g., simultaneously) the dielectric constant and the dielectric loss of the photosensitive resin composition including the controlled or selected structure of the polyimide resin as in Chemical Formula 1 may be reduced.

For example, by further controlling or selecting the type (kind) of linking group or substituent of the polyimide resin represented by Chemical Formula 1, the dielectric constant and dielectric loss may further be reduced.

For example, in Chemical Formula 1, R¹ and R² may each independently be represented by Chemical Formula R.

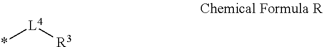

In Chemical Formula R,
R³ may be a (meth)acrylate group, and
L⁴ may be a substituted or unsubstituted C1 to C20 alkylene group.

For example, the polyimide resin represented by Chemical Formula 1 may further include a functional group represented by Chemical Formula S at at least one of both terminal ends.

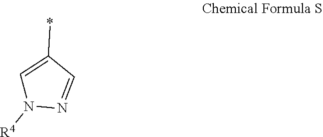

In Chemical Formula S,
R⁴ may be a hydrogen atom or a substituted or unsubstituted C1 to C20 alkyl group.

For example, the polyimide resin represented by Chemical Formula 1 may further include a functional group represented by Chemical Formula S at both terminal ends.

The photosensitive resin composition including the polyimide resin represented by Chemical Formula 1 having a functional group represented by Chemical Formula S at a terminal end may have further improved or enhanced elongation and reliability.

For example, in Chemical Formula S, R⁴ may be a substituted or unsubstituted C1 to C20 alkyl group. In this case, the effect of improving or enhancing the elongation and reliability may be much greater than if (e.g., when) R⁴ is a hydrogen atom.

For example, in Chemical Formula 1, n may be an integer of 0 to 2.

For example, in Chemical Formula 1, n may be an integer of 0. In this case, the elongation may be better than if (e.g., when) n is an integer from 1 to 10.

For example, in Chemical Formula 1, n may be an integer of 1 to 10. In this case, a lower dielectric loss may be achieved than if (e.g., when) n is an integer of 0.

For example, in Chemical Formula 1, Y¹ may be a C1 to C20 alkylene group unsubstituted or substituted with an alkyl group. In this case, it may have lower dielectric loss and higher elongation than if (e.g., when) Y¹ is an unsubstituted alkylene group.

In Chemical Formula 1, Y¹ may be an unsubstituted C6 to C20 alkylene group. In this case, it may have lower dielectric loss and higher elongation than if (e.g., when) Y¹ is an unsubstituted C1 to C5 alkylene group.

For example, the polyimide resin represented by Chemical Formula 1 may be represented by any one selected from among Chemical Formula 1-1 to Chemical Formula 1-4.

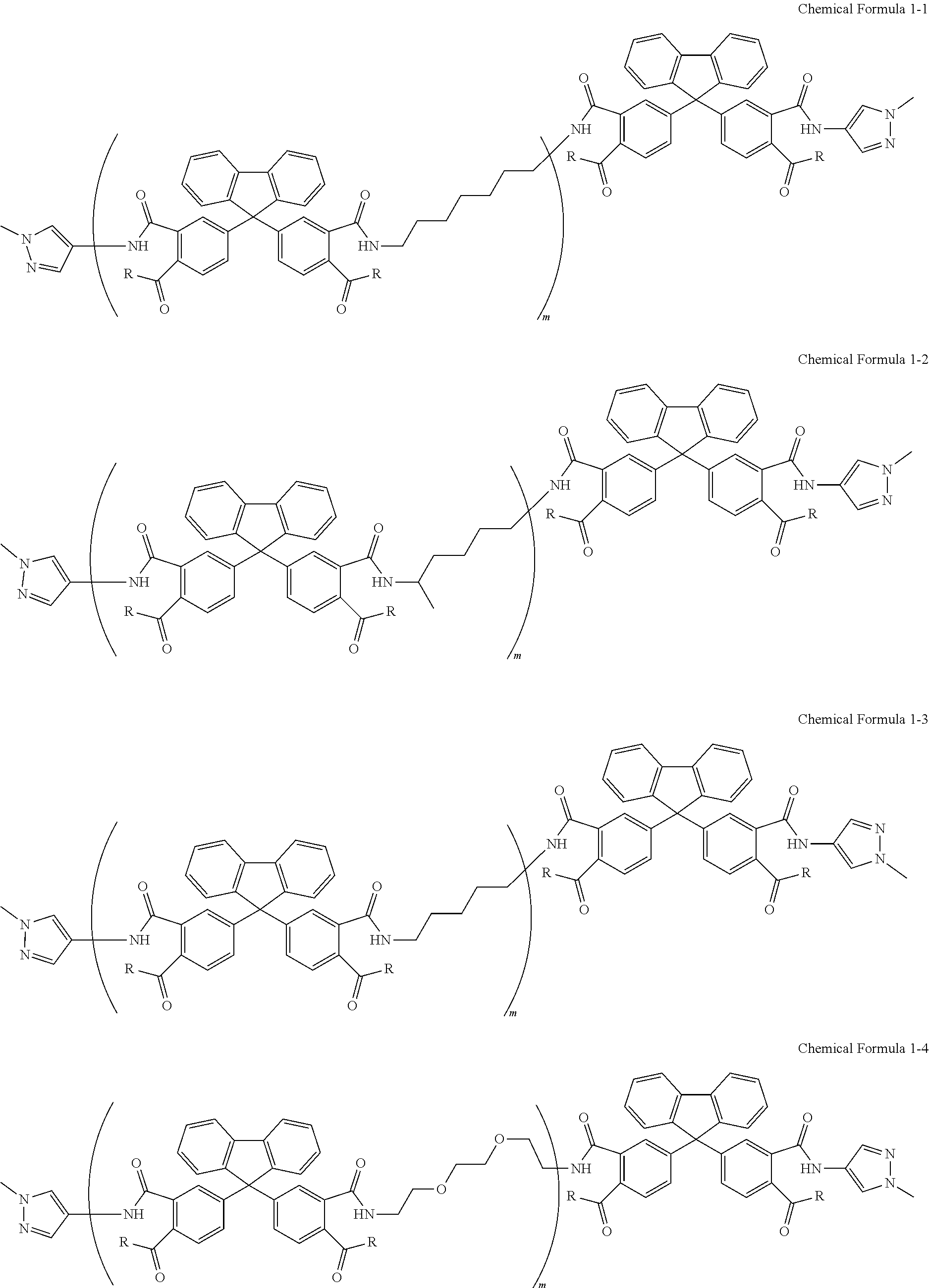

In Chemical Formula 1-1 to Chemical Formula 1-4,
R may be represented by Chemical Formula 4,

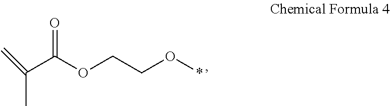 [SMILES: *OCCOC(=O)C(=C)C]

m may be an integer of 1 to 100.

The weight average molecular weight (Mw) of the polyimide resin represented by Chemical Formula 1 may be about 3,000 g/mol to about 300,000 g/mol. If (e.g., when) the weight average molecular weight of the polyimide resin is within the foregoing range, sufficient or suitable physical properties may be obtained, and the solubility in organic solvents is improved or enhanced, making handling easy.

### (B) Photopolymerizable Compound

The photosensitive resin composition according to one or more embodiments may further include a photopolymerizable compound. The photopolymerizable compound may be a single compound or a mixture of two different compounds.

The photopolymerizable compound may be a compound including at least two functional groups represented by Chemical Formula 5.

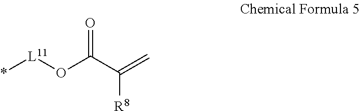

In Chemical Formula 5,
R⁸ may be a hydrogen atom or a substituted or unsubstituted C1 to C10 alkyl group, and
L¹¹ may be a single bond or a substituted or unsubstituted C1 to C10 alkylene group.

For example, the compound including at least two functional groups represented by Chemical Formula 5 may include two to six functional groups represented by Chemical Formula 5. In this case, sufficient or suitable polymerization may be induced during exposure in the pattern formation process to form a pattern with excellent or suitable heat resistance, light resistance, and chemical resistance.

For example, the compound including at least two functional groups represented by Chemical Formula 5 may be a compound represented by any one selected from among Chemical Formula 6 to Chemical Formula 8, but embodiments of the present disclosure are not necessarily limited thereto.

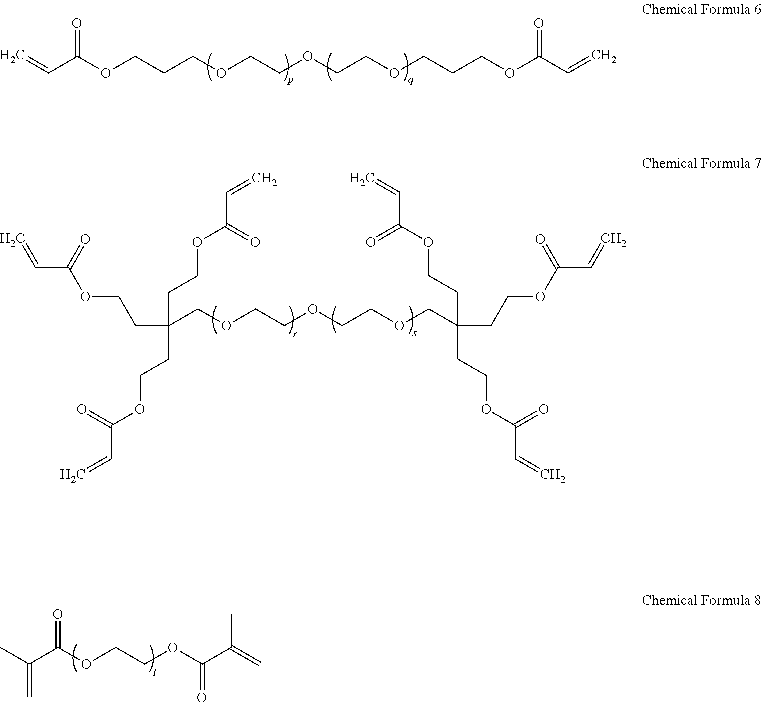

In Chemical Formula 6 to Chemical Formula 8,
p, q, r, s, and t may each independently be an integer of 1 to 10.

If (e.g., when) the photopolymerizable compound is a mixture of two different compounds, the other one of the two compounds may be a mono- or multi-functional ester compound of (meth)acrylic acid having at least one unsaturated double bond (e.g., an unsaturated carbon-carbon double bond).

The mono- or multi-functional ester compound of (meth)acrylic acid having at least one unsaturated double bond (e.g., an unsaturated carbon-carbon double bond) may be, for example, ethylene glycol di(meth)acrylate, diethylene glycol di(meth)acrylate, triethylene glycol di(meth)acrylate, propylene glycol di(meth)acrylate, neopentyl glycol di(meth)acrylate, 1,4-butanediol di(meth)acrylate, 1,6-hexanediol di(meth)acrylate, bisphenol A di(meth)acrylate, pentaerythritol di(meth)acrylate, pentaerythritol tri(meth)acrylate, pentaerythritol tetra(meth)acrylate, pentaerythritol hexa(meth)acrylate, dipentaerythritol di(meth)acrylate, dipentaerythritol tri(meth)acrylate, dipentaerythritol penta(meth)acrylate, dipentaerythritol hexa(meth)acrylate, bisphenol A epoxy(meth)acrylate, ethylene glycol monomethyl ether (meth)acrylate, trimethylolpropane tri(meth)acrylate, tris(meth)acryloyloxyethyl phosphate, novolac epoxy (meth)acrylate, or a (e.g., any suitable) combination thereof.

Commercially-available products of the monofunctional or multifunctional ester compound of (meth)acrylic acid having at least one unsaturated double bond (e.g., an unsaturated carbon-carbon double bond) are as follows. Examples of the mono-functional ester of (meth)acrylic acid may include Aronix M-101®, M-111®, M-114® (Toagosei Chemistry Industry Co., Ltd.); KAYARAD TC-110S®, TC-120S® (Nippon Kayaku Co., Ltd.); V-158®, V-2311® (Osaka Organic Chemical Ind., Ltd.), and/or the like. Examples of a di-functional ester of (meth)acrylic acid may include Aronix M-210®, M-240®, M-6200® (Toagosei Chemistry Industry Co., Ltd.), KAYARAD HDDA®, HX-220®, R-604® (Nippon Kayaku Co., Ltd.), V-260®, V-312®, V-335 HP® (Osaka Organic Chemical Ind., Ltd.), and/or the like. Examples of a tri-functional ester of (meth)acrylic acid may include Aronix M-309®, M-400®, M-405®, M-450®, M-7100®, M-8030®, M-8060® (Toagosei Chemistry Industry Co., Ltd.), KAYARAD TMPTA®, KAYARAD DPCA-20®, KAYARAD DPCA-30®, KAYARAD DPCA-60®, KAYARAD DPCA-120® (Nippon Kayaku Co., Ltd.), V-295®, V-300®, V-360®, V-GPT®, V-3PA®, V-400® (Osaka Yuki Kayaku Kogyo Co. Ltd.), and/or the like. These may be used alone or as a mixture of two or more.

The photopolymerizable compound may be utilized after being treated with an acid anhydride to provide better or more suitable developability.

The photopolymerizable compound may be included in an amount of about 5 parts by weight to about 20 parts by weight, for example, about 7 parts by weight to about 15 parts by weight based on 100 parts by weight of the polyimide resin. If (e.g., when) the photopolymerizable compound is included within the foregoing range, curing occurs sufficiently or suitably, reliability is excellent or suitable, heat resistance, light resistance, and chemical resistance of the pattern may be improved or enhanced, and resolution and adhesion may also be improved or enhanced.

### (C) Photopolymerization Initiator

The photosensitive resin composition according to one or more embodiments may further include a photopolymerization initiator. The photopolymerization initiator may include an acetophenone-based compound, a benzophenone-based compound, a thioxanthone-based compound, a benzoin-based compound, a triazine-based compound, an oxime-based compound, and/or the like.

Examples of the acetophenone-based compound may include 2,2′-diethoxy acetophenone, 2,2′-dibutoxy acetophenone, 2-hydroxy-2-methylpropinophenone, p-t-butyltrichloro acetophenone, p-t-butyldichloro acetophenone, 4-chloroacetophenone, 2,2′-dichloro-4-phenoxy acetophenone, 2-methyl-1-(4-(methylthio)phenyl)-2-morpholinopropan-1-one, 2-benzyl-2-dimethylamino-1-(4-morpholinophenyl)-butan-1-one, and/or the like.

Examples of the benzophenone-based compound may include benzophenone, benzoyl benzoate, benzoyl methyl benzoate, 4-phenyl benzophenone, hydroxy benzophenone, acrylated benzophenone, 4,4′-bis(dimethyl amino)benzophenone, 4,4′-bis(diethylamino)benzophenone, 4,4′-dimethylaminobenzophenone, 4,4′-dichlorobenzophenone, 3,3′-dimethyl-2-methoxybenzophenone, and/or the like.

Examples of the thioxanthone-based compound may include thioxanthone, 2-chlorothioxanthone, 2-methylthioxanthone, isopropyl thioxanthone, 2,4-diethyl thioxanthone, 2,4-diisopropyl thioxanthone, and/or the like.

Examples of the benzoin-based compound may include benzoin, benzoin methyl ether, benzoin ethyl ether, benzoin isopropyl ether, benzoin isobutyl ether, benzyl dimethyl ketal, and/or the like.

Examples of the triazine-based compound may include 2,4,6-trichloro-s-triazine, 2-phenyl 4,6-bis(trichloromethyl)-s-triazine, 2-(3′, 4′-dimethoxystyryl)-4,6-bis(trichloromethyl)-s-triazine, 2-(4′-methoxynaphthyl)-4,6-bis(trichloromethyl)-s-triazine, 2-(p-methoxyphenyl)-4,6-bis(trichloromethyl)-s-triazine, 2-(p-tolyl)-4,6-bis(trichloro methyl)-s-triazine, 2-biphenyl 4,6-bis(trichloromethyl)-s-triazine, bis(trichloromethyl)-6-styryl-s-triazine, 2-(naphthol-yl)-4,6-bis(trichloromethyl)-s-triazine, 2-(4-methoxynaphtho1-yl)-4,6-bis(trichloromethyl)-s-triazine, 2-4-bis(trichloromethyl)-6-piperonyl-s-triazine, 2-4-bis(trichloromethyl)-6-(4-methoxystyryl)-s-triazine, and/or the like.

Examples of the oxime compounds may include an O-acyloxime compound, 2-(O-benzoyloxime)-1-[4-(phenylthio)phenyl]-1,2-octanedione, 1-(O-acetyloxime)-1-[9-ethyl-6-(2-methylbenzoyl)-9H-carbazol-3-yl]ethanone, O-ethoxycarbonyl-α-oxyamino-1-phenylpropan-1-one, and/or the like. Examples of the O-acyloxime compounds may include 1,2-octanedione, 2-dimethylamino-2-(4-methylbenzyl)-1-(4-morpholin-4-yl-phenyl)-butan-1-one, 1-(4-phenylsulfanylphenyl)-butane-1,2-dione-2-oxime-O-benzoate, 1-(4-phenylsulfanylphenyl)-octane-1,2-dione-2-oxime-O-benzoate, 1-(4-phenylsulfanylphenyl)-octane-1-one oxime-O-acetate, and 1-(4-phenylsulfanylphenyl)-butane-1-one oxime-O-acetate.

The photopolymerization initiator may include a carbazole-based compound, a diketone-based compound, a sulfonium borate-based compound, a diazo-based compound, an imidazole-based compound, a biimidazole-based compound, and a fluorene-based compound, in addition to the foregoing compounds.

The photopolymerization initiator may be included in an amount of about 3 parts by weight to about 10 parts by weight, for example, about 4 parts by weight to about 9 parts by weight, based on 100 parts by weight of the polyimide resin. If (e.g., when) the photoinitiator is included within the foregoing range, photopolymerization occurs sufficiently or suitably as described in one or more embodiments, preventing or reducing a decrease in sensitivity characteristics and improving or enhancing transmittance.

### (D) Solvent

The solvent may be a material that is compatible with, but does not react with, the polyimide resin, the photopolymerizable compound, and the photopolymerization initiator.

Examples of the solvent may include alcohols, such as methanol, ethanol, and/or the like; ethers, such as dichloroethylether, n-butylether, diisoamylether, methylphenylether, tetrahydrofuran, and/or the like; glycol ethers, such as ethylene glycol monomethyl ether, ethylene glycol monoethyl ether, ethylene glycol dimethyl ether, and/or the like; cellosolve acetates, such as methyl cellosolve acetate, ethyl cellosolve acetate, diethyl cellosolve acetate, and/or the like; carbitols, such as methyl ethyl carbitol, diethyl carbitol, diethylene glycol monomethyl ether, diethylene glycol monoethyl ether, diethylene glycol dimethyl ether, diethylene glycol ethyl methyl ether, diethylene glycol diethyl ether, and/or the like; propylene glycol alkyl ether acetates, such as propylene glycol methyl ether acetate, propylene glycol propyl ether acetate, and/or the like; aromatic hydrocarbons, such as toluene, xylene, and/or the like; ketones, such as methylethylketone, cyclohexanone, 4-hydroxy-4-methyl-2-pentanone, methyl-n-propylketone, methyl-n-butylketone, methyl-n-amylketone, 2-heptanone, and/or the like; saturated aliphatic monocarboxylic acid alkyl esters, such as ethyl acetate, n-butyl acetate, isobutyl acetate, and/or the like; lactate esters, such as methyl lactate, ethyl lactate, and/or the like; oxy acetic acid alkyl esters, such as oxy methyl acetate, oxy ethyl acetate, oxy butyl acetate, and/or the like; alkoxy acetic acid alkyl esters, such as methoxy methyl acetate, methoxy ethyl acetate, methoxy butyl acetate, ethoxy methyl acetate, ethoxy ethyl acetate, and/or the like; 3-oxypropionic acid alkyl esters, such as 3-oxymethyl propionate, 3-oxyethyl propionate, and/or the like; 3-alkoxypropionic acid alkyl esters, such as 3-methoxymethyl propionate, 3-methoxyethyl propionate, 3-ethoxyethyl propionate, 3-ethoxymethyl propionate, and/or the like; 2-oxypropionic acid alkyl esters, such as 2-oxymethyl propionate, 2-oxyethyl propionate, 2-oxypropyl propionate, and/or the like; 2-alkoxypropionic acid alkyl esters, such as 2-methoxymethyl propionate, 2-methoxyethyl propionate, 2-ethoxyethyl propionate, 2-ethoxymethyl propionate, and/or the like; 2-oxy-2-methylpropionic acid esters, such as 2-oxy-2-methylmethyl propionate, 2-oxy-2-methylethyl propionate, and/or the like, monooxy monocarboxylic acid alkyl esters of 2-alkoxy-2-methyl alkyl propionates, such as 2-methoxy-2-methylmethyl propionate, 2-ethoxy-2-methylethyl propionate, and/or the like; esters, such as 2-hydroxyethyl propionate, 2-hydroxy-2-methylethyl propionate, hydroxy ethyl acetate, 2-hydroxy-3-methyl methyl butanoate, and/or the like; ketonate esters, such as ethyl pyruvate, and/or the like. Also, a high boiling point solvent, such as N-methylformamide, N,N-dimethyl formamide, N-methylformanilide, N-methylacetamide, N,N-dimethyl acetamide, N-methylpyrrolidone, dimethyl sulfoxide, benzyl ethyl ether, dihexyl ether, acetylacetone, isophorone, caproic acid, caprylic acid, 1-octanol, 1-nonanol, benzyl alcohol, benzyl acetate, ethyl benzoate, diethyl oxalate, diethyl maleate, γ-butyrolactone, 3-methyl benzoate, ethylene carbonate, propylene carbonate, phenyl cellosolve acetate, and/or the like may be also used.

The solvent may be included in an amount of about 100 to about 500 parts by weight based on 100 parts by weight of the polyimide resin. If (e.g., when) the solvent is included within the foregoing range, the photosensitive resin composition may have appropriate or suitable viscosity, resulting in excellent or suitable processability if (e.g., when) manufacturing photosensitive resin layers.

### (E) Other Additives

The photosensitive resin composition according to one or more embodiments may further include other additives.

The photosensitive resin composition may include an additive, such as a diacid (e.g., malonic acid), an alkanolamine (e.g., 3-amino-1,2-propanediol), a photosensitizer, a leveling agent, a radical scavenger, a silane-based coupling agent, a surfactant, an organic acid, an epoxy compound, a thermal latent acid generator, a development control agent, a curing agent, or a (e.g., any suitable) combination thereof, in order to prevent or reduce stains or spots during coating, to achieve leveling properties, or to prevent or reduce the generation of residues due to non-development. An amount of these additives used may be easily or suitably adjusted depending on the desired or suitable physical properties.

For example, the organic acid may improve or enhance electrical characteristics of the photosensitive resin composition according to one or more embodiments, ultimately contributing to reducing the dielectric constant and dielectric loss.

For example, the organic acid may include citric acid. The citric acid may play a role in improving or enhancing ion conductivity in an electrolyte system, which may affect the electrical characteristics, for example, if (e.g., when) the citric acid is doped into an alginic acid-based solid biopolymer electrolyte, the electrolyte may exhibit a non-Debye behavior, which may be analyzed through a composite dielectric constant (ε*) and a complex electrical modulus (M*). This result suggests that the citric acid may include the abnormal dielectric behavior in the system in which the citric acid is included, and if (e.g., when) such a citric acid is added to a photosensitive resin composition, the citric acid may affect its dielectric characteristics through chemical interaction and structural change of a resin, ultimately contributing to reducing the dielectric constant and the dielectric loss.

For example, the silane-based coupling agent may have a reactive substituent, such as a vinyl group, a carboxyl group, a methacryloxy group, an isocyanate group, and/or an epoxy group, to improve or enhance adhesion to the substrate, and may have a different structure from the silane compound.

Examples of the silane-based coupling agent may include trimethoxysilyl benzoic acid, γ-methacryloxypropyltrimethoxysilane, vinyltriacetoxysilane, vinyltrimethoxysilane, γ-isocyanatepropyltriethoxysilane, γ-glycidoxypropyltrimethoxysilane, β-(3,4-epoxycyclohexyl)ethyltrimethoxysilane, and/or the like. These may be used alone or in a mixture of two or more.

The silane-based coupling agent may be included in an amount of about 0.01 parts by weight to about 10 parts by weight based on 100 parts by weight of the photosensitive resin composition. If (e.g., when) the silane-based coupling agent is included within the foregoing range, adhesion, storage properties, and/or the like may be improved or enhanced.

For example, the surfactant may be added to prevent or reduce film thickness unevenness or improve or enhance developability and may include a fluorine-based surfactant and/or a silicone-based surfactant.

Examples of the fluorine-based surfactant may include a commercial fluorine-based surfactant, such as BM-1000®, BM-1100®, and/or the like of BM Chemie Inc.; MEGAFACE F 142D®, MEGAFACE F 172®, MEGAFACE F 173®, MEGAFACE F 183®, MEGAFACE F 554®, and/or the like of Dainippon Ink Kagaku Kogyo Co., Ltd.; FULORAD FC-135®, FULORAD FC-170C®, FULORAD FC-430®, FULORAD FC-431®, and/or the like of SUMITOMO 3M Co., Ltd.; SURFLON S-112®, SURFLON S-113®, SURFLON S-131®, SURFLON S-141®, SURFLON S-145®, and/or the like of Asahi Glass Co., Ltd.; SH-28PA®, SH-190®, SH-193®, SZ-6032®, SF-8428®, and/or the like of Toray Silicone Co., Ltd.

The silicone-based surfactant may be a commercial silicone-based surfactant, such as BYK-307, BYK-333, BYK-361N, BYK-051, BYK-052, BYK-053, BYK-067A, BYK-077, BYK-301, BYK-322, BYK-325, BYK-378, and/or the like of BYK Chem.

The surfactant may be used in an amount of about 0.001 parts by weight to about 5 parts by weight based on 100 parts by weight of the photosensitive resin composition. If (e.g., when) the surfactant is included within the foregoing range, coating uniformity may be ensured (e.g., improved or enhanced), stains may not occur, and wetting on indium tin oxide (ITO) substrates, glass substrates, Si wafers, SiNₓ (wherein 0<x≤2; e.g., Si₃N₄) wafers, and Cu substrates may be improved or enhanced.

In one or more embodiments, the photosensitive resin composition may further include an epoxy compound to improve or enhance adhesion and/or the like with a substrate. Examples of the epoxy compound may include a phenol novolac epoxy compound, a tetramethyl biphenyl epoxy compound, a bisphenol A epoxy compound, an alicyclic epoxy compound, or a (e.g., any suitable) combination thereof.

The epoxy compound may be used in an amount of about 0.01 part by weight to about 5 parts by weight based on 100 parts by weight of the resin composition. If (e.g., when) the epoxy compound is included within the foregoing range, storage properties, adhesive force, and other properties may be improved or enhanced.

In one or more embodiments, the photosensitive resin composition may further include a thermal latent acid generator. Examples of the thermal latent acid generator may include arylsulfonic acids, such as p-toluenesulfonic acid and benzenesulfonic acid; perfluoroalkylsulfonic acids, such as trifluoromethanesulfonic acid, trifluorobutanesulfonic acid, and/or the like; alkylsulfonic acids, such as methanesulfonic acid, ethanesulfonic acid, butanesulfonic acid, and/or the like; or a (e.g., any suitable) combination thereof, but embodiments of the present disclosure are not limited thereto.

Furthermore, the photosensitive resin composition may include other additives, such as an antioxidant, a stabilizer, and/or the like in a set or predetermined amount unless they deteriorate properties of the photosensitive resin composition.

One or more embodiments of the present disclosure provide a photosensitive resin layer, for example, a semiconductor redistribution layer insulation layer manufactured by exposing, developing, and curing the photosensitive resin composition as described in one or more embodiments.

### Method of Manufacturing the Photosensitive Resin Layer

The method of manufacturing the photosensitive resin layer is as follows.

### (1) Coating and Film Formation

The photosensitive resin composition may be coated to have a desired or suitable thickness on a substrate, such as a glass substrate, an ITO substrate, a Si wafer, a SiNx wafer, a Cu substrate, and/or the like, which undergoes a set or predetermined pretreatment, using a spin coating method, a slit coating method, a roll coating method, a screen-printing method, an applicator method, and/or the like, and may be heated in a range of about 70° C. to about 150° C. for about 1 minute to 10 minutes to remove a solvent and thereby to form a film.

### (2) Exposure

After disposing a mask to form a necessary or desired pattern on the obtained photosensitive resin layer, exposure may be performed by irradiating an actinic ray in a range of 200 nm to 500 nm. As a light source used for irradiation, a low-pressure mercury lamp, a high-pressure mercury lamp, an ultra-high pressure mercury lamp, a metal halide lamp, an argon gas laser, and/or the like may be used, and in one or more cases, an X-ray, an electron beam, and/or the like may be used.

The exposure dose varies depending on the type (kind), mixing amount, and dry film thickness of each component of the composition, but may be less than 500 mJ/cm² (based on a 365 nm sensor) if (e.g., when) using a high-pressure mercury lamp.

### (3) Development

In the development method, following the exposure step (e.g., act or task), alkali aqueous (e.g., water-soluble) solution or an organic solvent may be used as a developer to dissolve and remove unnecessary parts, leaving only the exposed parts remaining to form a pattern.

### (4) Post-Processing

There may be a post-heating process to obtain a pattern excellent or suitable in terms of heat resistance, light resistance, adhesion, crack resistance, chemical resistance, high strength, and storage stability of the image pattern obtained by development in the process as described in one or more embodiments. For example, after development, it may be heated in a nitrogen atmosphere in an oven at about 200° C. to about 400° C. for 1 hour or more.

One or more embodiments of the present disclosure provide an electronic device including the photosensitive resin layer (e.g., semiconductor redistribution layer insulation layer).

Hereinafter, one or more embodiments of the present disclosure are illustrated in more detail with reference to examples. However, the following examples are only examples of the present disclosure, and embodiments of the present disclosure are not limited by the following examples.

### EXAMPLES

### 1 Synthesis of Resin

### Synthesis Example 1

65 mmol of 9,9-bis(3,4-dicarboxyphenyl)fluorene dianhydride, 17.72 g (136 mmol) of methacrylic acid-2-hydroxyethyl (HEMA), and a catalyst amount of 1,8-diazabicyclo[5.4.0]undeca-7-ene (DBU) were dissolved in N-methyl-2-pyrrolidone, whose amount was 4 times that of the pyromellitic acid dianhydride, and then, stirred at room temperature for 48 hours to obtain Ester Solution 1.

149 mmol of 9,9-bis(3,4-dicarboxyphenyl)fluorene dianhydride, 42 g (323 mmol) of methacrylic acid-2-hydroxyethyl (HEMA), and a catalyst amount of DBU were dissolved in N-methyl-2-pyrrolidone, whose amount was 4 times that of the anhydride, and then, stirred at room temperature for 48 hours to obtain Ester Solution 2. After mixing Ester Solution 1 and Ester Solution 2, while cooling at 0° C., 2.2 equivalents of thionyl chloride based on a total amount of Ester Solution 1 and Ester Solution 2 was added dropwise thereto and then, stirred for 1 hour, preparing an acid chloride solution.

After dissolving 90 mmol of heptane-1,7-diamine, 10 mmol of 4-amino-1-methyl-1H-pyrazole, and two equivalents of pyridine to that of the thionyl chloride in 120 g of N-methyl-2-pyrrolidone, the solution was added dropwise to the acid chloride solution at 0° C. When the addition was completed, the reaction solution was added dropwise to distilled water to form precipitates, which were collected by filtration, three times washed with distilled water, and vacuum-dried to obtain a polyimide resin. The obtained polymer (polyimide resin) had a weight average molecular weight of 25,500 g/mol.

### Synthesis Example 2

A polyimide resin was obtained in substantially the same manner as in Synthesis Example 1 except that 1,5-diamino-1-methylpentane was used instead of the heptane-1,7-diamine.

### Synthesis Example 3

A polyimide resin was obtained in substantially the same manner as in Synthesis Example 1 except that pentane-1,5-diamine was used instead of the heptane-1,7-diamine.

### Synthesis Example 4

A polyimide resin was obtained in substantially the same manner as in Synthesis Example 1 except that diamine represented by Chemical Formula N was used instead of the heptane-1,7-diamine.

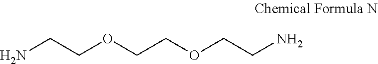

### Comparative Synthesis Example 1

While passing nitrogen through a four-necked flask equipped with a stirrer, a temperature controller, a nitrogen gas injection device, and a condenser, 0.58 mol of a dianhydride monomer represented by Chemical Formula A was added to 600 g of γ-butyrolactone (GBL), and then, 1.22 mol of 2-hydroxyethylmethacrylate (HEMA) was added thereto, and while stirring the mixture at room temperature, 1.16 mol of pyridine was added thereto to obtain a reaction mixture. The reaction mixture was reacted at room temperature for 16 hours and then, cooled to −10° C., and a solution prepared by dissolving 1.17 mol of dicyclohexylcarbodiimide (DCC) and 250 g of GBL was added in a dropwise fashion thereto over 30 minutes. After additionally stirring the mixture for 5 minutes, a solution of 0.54 mol of a diamine monomer represented by Chemical Formula B and 300 g of GBL were added thereto for 40 minutes and then, additionally stirred for 2 hours. After reacting at room temperature for 1 hour, 30 g of ethanol was added and stirred for 1 hour. Subsequently, GBL was added to the reaction solution to have a solid content (e.g., amount) of 18% and then, added to 3 L of ethanol to obtain precipitates. A polymer was separated therefrom through filtration, dissolved in 1.5 L of tetrahydrofuran (THF), and then, added in a dropwise fashion to 30 L of water to form precipitates, and the precipitates were separated through filtration and vacuum-dried. By drying at 50° C. under reduced pressure for 24 hours or more, a polyimide resin including a structural unit represented by Chemical Formula C was prepared. (Chemical Formula A and Chemical Formula B were polymerized in a molar ratio of 1:1)

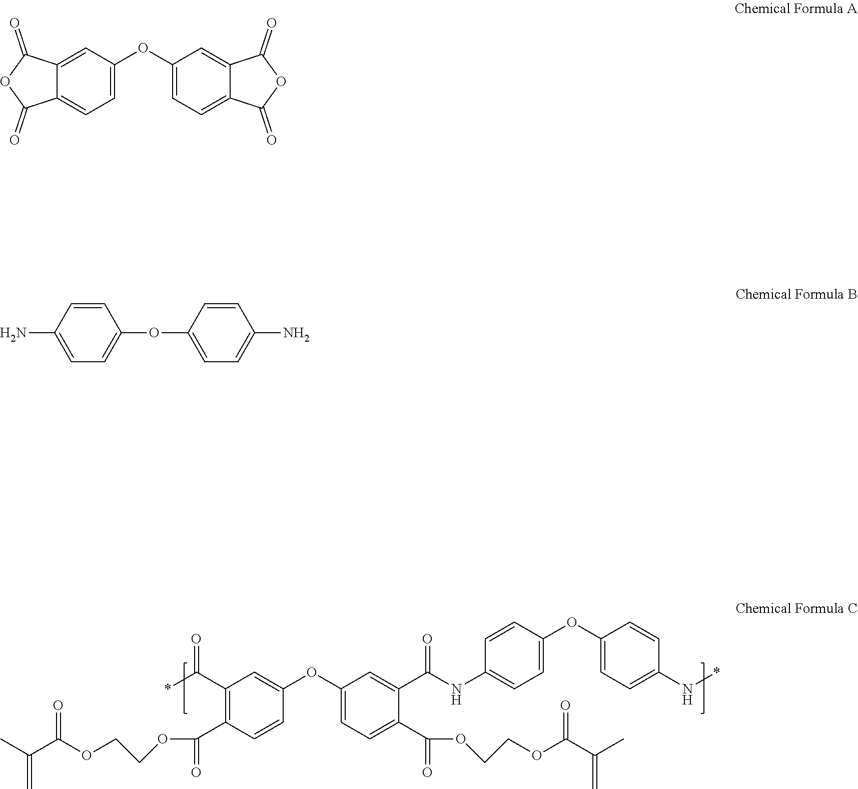

### Comparative Synthesis Example 2

78.0 g of 3,3′,4,4′-biphenyltetracarboxylic dianhydride (BPDA) and 123.4 g of 4,4′-oxydianiline (ODA) were added to a 2 L separable flask, and 181.2 g of 2-hydroxyethylmethacrylate (HEMA) and 400 mL of γ-butyrolactone were added thereto. While stirring at room temperature, 52.4 g of pyridine was added thereto to obtain a reaction mixture. After an exothermic reaction was over, the reaction mixture was cooled and then, additionally allowed to stand for 16 hours.

Subsequently, to the reaction mixture under the cooling, a solution prepared by dissolving 280.0 g of dicyclohexylcarbodiimide (DCC) in 150 mL of γ-butyrolactone was added over 40 minutes, while stirring. Then, a suspension prepared by suspending 123.4 g of 4,4′-oxybisbenzenamine in 440 mL of γ-butyrolactone was added thereto over 30 minutes, while stirring. Additionally, after stirring the mixture at room temperature for 2 hours, 30 mL of N,N-carbonyldiimidazole was added thereto and then, stirred for 1 hour. Subsequently, 400 mL of γ-butyrolactone was added thereto. Then, precipitates formed in the reaction mixture were removed by filtration, obtaining a reaction solution.

The obtained reaction solution was added to 3 L of ethanol to produce precipitates composed of a polymer. The produced polymer was collected by filtration and dissolved in 1.5 L of γ-butyrolactone to obtain a polymer solution. The obtained polymer solution was added dropwise to 14 L of water to precipitate the polymer, which was collected by filtration and vacuum-dried, obtaining a polyimide resin represented by Chemical Formula C-1.

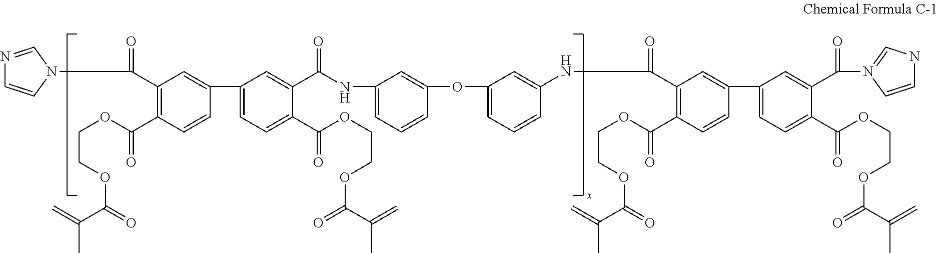

### Comparative Synthesis Example 3

A polyimide resin was obtained in substantially the same manner as in Comparative Synthesis Example 1 except that 9,9-bis(3,4-dicarboxyphenyl)fluorene dianhydride was used instead of the dianhydride monomer represented by Chemical Formula A.

### Comparative Synthesis Example 4

A polyimide resin was obtained in substantially the same manner as in Comparative Synthesis Example 2 except that diamine represented by Chemical Formula N was used instead of the 4,4′-oxydianiline.

### Preparation of Photosensitive Resin Composition

### Examples 1 to 4 and Comparative Examples 1 to 4

Each photosensitive resin composition was prepared according to the compositions as shown in Table 1. For example, a polyimide resin and a photopolymerizable compound are mixed, and a photopolymerization initiator, a photosensitizer, a radical scavenger, a silane-based coupling agent, an organic acid, and a solvent are added thereto and stirred sufficiently. Then, the negative type (kind) photosensitive resin compositions were obtained by filtering through a 0.45 μm polypropylene resin filter.

TABLE 1
unit: wt %

| | | | | | Compar- | Compar- | Compar- | Compar- |
|---|---|---|---|---|---|---|---|---|
| | | | | | ative | ative | ative | ative |
| | Exam- | Exam- | Exam- | Exam- | Exam- | Exam- | Exam- | Exam- |
| | ple 1 | ple 2 | ple 3 | ple 4 | ple 1 | ple 2 | ple 3 | ple 4 |
| Polyimide resin | 33.28 | 33.28 | 33.28 | 33.28 | 33.28 | 33.28 | 33.28 | 33.28 |
| | (Syn- | (Syn- | (Syn- | (Syn- | (Compar- | (Compar- | (Compar- | (Compar- |
| | thesis | thesis | thesis | thesis | ative | ative | ative | ative |
| | Exam- | Exam- | Exam- | Exam- | (Syn- | (Syn- | (Syn- | (Syn- |
| | ple 1) | ple 2) | ple 3) | ple 4) | thesis | thesis | thesis | thesis |
| | | | | | Exam- | Exam- | Exam- | Exam- |
| | | | | | ple 1) | ple 2) | ple 3) | ple 4) |
| Photopolymerizable | 3.69 | 3.69 | 3.69 | 3.69 | 3.69 | 3.69 | 3.69 | 3.69 |
| compound | | | | | | | | |
| Photopolymerization | 1.66 | 1.66 | 1.66 | 1.66 | 1.66 | 1.66 | 1.66 | 1.66 |
| initiator | | | | | | | | |
| Photosensitizer | 3.32 | 3.32 | 3.32 | 3.32 | 3.32 | 3.32 | 3.32 | 3.32 |
| Radical scavenger | 0.55 | 0.55 | 0.55 | 0.55 | 0.55 | 0.55 | 0.55 | 0.55 |
| Silane-based | 0.92 | 0.92 | 0.92 | 0.92 | 0.92 | 0.92 | 0.92 | 0.92 |
| coupling agent | | | | | | | | |
| Organic acid | 0.18 | 0.18 | 0.18 | 0.18 | 0.18 | 0.18 | 0.18 | 0.18 |
| Solvent 1 | 50.76 | 50.76 | 50.76 | 50.76 | 50.76 | 50.76 | 50.76 | 50.76 |
| Solvent 2 | 5.64 | 5.64 | 5.64 | 5.64 | 5.64 | 5.64 | 5.64 | 5.64 |

Photopolymerizable compound: tetraethylene glycol dimethacrylate (TCI)
Photopolymerization initiator: PBG-305 (Tronly)
Photosensitizer: N-phenyl diethanolamine (Shin-Etsu)
Radical Scavenger: CX-1790 (Syensqo)
Silane-based coupling agent: A-187 (Momentive Performance Materials)
Organic acid: Citric acid (TCI)
Solvent 1: γ-Butyrolactone (Daejeong Chemical Co., Ltd.)
Solvent 2: Dimethylsulfoxide (Daejeong Chemical Co., Ltd.)

### Evaluation

The photosensitive resin compositions according to Examples 1 to 4 and Comparative Examples 1 to 4 were coated on an 8-inch silicon wafer and baked at 100° C. for 4 minutes to obtain films of about 10.0 μm. Then, after cooling at room temperature for 60 seconds, light at 700 msec was irradiated with an i-line stepper (NSR-2005i10C, Nikon Inc.) thereto to induce a photocuring reaction in the photosensitive portion. The exposed substrate was twice developed with a 100% cyclopentatnone solvent at room temperature for 60 seconds in a puddle method and then, washed with a 100% propylene glycol monomethyl ether acetate (PGMEA) solvent for 60 seconds. Then, the developed wafer was cured in a 220° C. oven in a nitrogen atmosphere for 2 hours.

Elongation Evaluation: The cured wafer was immersed in a HCl 5% solution for 1 hour to form a PID film. The film was cut into a size of 1 cm*10 cm to obtain a specimen, which was used to measure elongation at room temperature by using a tensile tester (HZ-1003, Shimadzu Corp.), and the results are shown in Table 2.

Evaluation of dielectric loss factor (Df): The manufactured film (cured film) was dried at 100° C. for 30 minutes and then aged for 24 hours in a constant temperature and humidity chamber maintained at 23° C. and 50% relative humidity to perform pretreatment. Then, the dielectric characteristics were measured at a frequency of 10 GHz using the Split Post Dielectric Resonator (SPDR) measurement method using Keysight's ENA, and the results are shown in Table 2.

Reliability evaluation: The manufactured film (cured film) is subjected to 2000 cycles of thermal cycle (−55° C. to 125° C.), which is the reliability condition. Then, field emission scanning electron microscope (FE-SEM) was used to check whether cracks were generated between PI and Cu, and the results are shown in Table 2.

TABLE 2

| | Elongation (%) | Df (10 GHz) | Reliability |
|---|---|---|---|
| Example 1 | 79 | 0.008 | OK |
| Example 2 | 80 | 0.006 | OK |
| Example 3 | 77 | 0.010 | OK |
| Example 4 | 74 | 0.005 | OK |
| Comparative Example 1 | 68 | 0.020 | OK |
| Comparative Example 2 | 69 | 0.017 | NG |
| Comparative Example 3 | 73 | 0.025 | NG |
| Comparative Example 4 | 66 | 0.026 | NG |

Through Table 2, the photosensitive resin composition according to Examples 1 to 4 has a low dielectric loss factor while also having excellent or suitable elongation and reliability, and is therefore suitable for use as a composition for a semiconductor redistribution layer.

A patterning device, a developer composition manufacturing device, and/or any other relevant devices or components according to one or more embodiments of the present disclosure described herein may be implemented utilizing any suitable hardware, firmware (e.g., an application-specific integrated circuit), software, or a combination of software, firmware, and hardware. For example, the one or more suitable components of the device may be formed or arranged on one integrated circuit (IC) chip or on separate IC chips. Further, the one or more suitable components of the device may be implemented on a flexible printed circuit film, a tape carrier package (TCP), a printed circuit board (PCB) or formed or arranged on one substrate. Further, the one or more suitable components of the device may be a process or thread, running on one or more processors, in one or more computing devices, executing computer program instructions and interacting with other system components to perform the one or more suitable functionalities as described herein. The computer program instructions may be stored in a memory which may be implemented in a computing device using a standard memory device, such as, for example, a random access memory (RAM). The computer program instructions may also be stored in other non-transitory computer readable media such as, for example, a CD-ROM, flash drive, and/or the like. Also, a person of skill in the art should recognize that the functionality of one or more suitable computing devices may be combined or integrated into a single computing device, or the functionality of a particular computing device may be distributed across one or more other computing devices without departing from the scope of the present disclosure.

While the subject matter of the present disclosure has been described in connection with what is presently considered to be practical example embodiments, it is to be understood that the present disclosure is not limited to the disclosed embodiments, but, on the contrary, is intended to cover one or more suitable modifications and equivalent arrangements included within the spirit and scope of the appended claims and equivalents thereof. It therefore will be understood that one or more embodiments described herein are just illustrative but not limitative in all aspects.

What is claimed is:

1. A photosensitive resin composition, comprising:
a polyimide resin represented by Chemical Formula 1;
a photopolymerizable compound;
a photopolymerization initiator; and
a solvent: 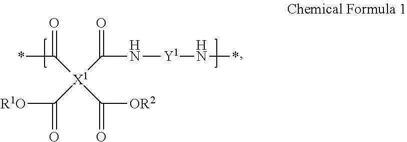
wherein, in Chemical Formula 1,
R¹ and R² are each independently a substituted or unsubstituted C1 to C20 alkyl group, a substituted or unsubstituted C3 to C20 cycloalkyl group, a substituted or unsubstituted C6 to C20 aryl group, or a substituted or unsubstituted C2 to C20 heterocyclic group, and
X¹ is represented by Chemical Formula 2, 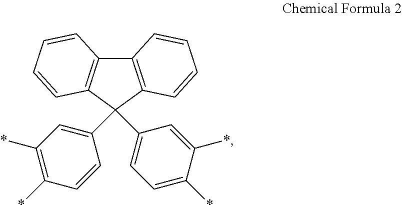
Y¹ is represented by Chemical Formula 3, 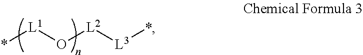
and
wherein, in Chemical Formula 3,
L¹ to L³ are each independently a substituted or unsubstituted C1 to C20 alkylene group or a substituted or unsubstituted C6 to C20 arylene group, and n is an integer of 0 to 10.

2. The photosensitive resin composition as claimed in claim 1, wherein:
R¹ and R² are each independently represented by Chemical Formula R: 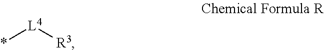
and
wherein, in Chemical Formula R,
R³ is a (meth)acrylate group, and
L⁴ is a substituted or unsubstituted C1 to C20 alkylene group.

3. The photosensitive resin composition as claimed in claim 1, wherein:
the polyimide resin comprises a functional group represented by Chemical Formula S at at least one of both terminal ends: 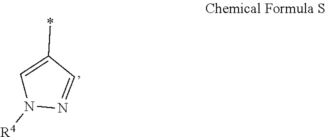
and
wherein, in Chemical Formula S,
R⁴ is a hydrogen atom or a substituted or unsubstituted C1 to C20 alkyl group.

4. The photosensitive resin composition as claimed in claim 1, wherein:
n is an integer of 0 to 2.

5. The photosensitive resin composition as claimed in claim 1, wherein:
Y¹ is a C1 to C20 alkylene group unsubstituted or substituted with an alkyl group.

6. The photosensitive resin composition as claimed in claim 1, wherein:
Y¹ is an unsubstituted alkylene group.

7. The photosensitive resin composition as claimed in claim 1, wherein:
Y¹ is unsubstituted or substituted C6 to C20 alkylene group.

8. The photosensitive resin composition as claimed in claim 1, wherein:
Y¹ is an unsubstituted C1 to C5 alkylene group.

9. The photosensitive resin composition as claimed in claim 1, wherein:
the polyimide resin represented by Chemical Formula 1 is represented by any one selected from among Chemical Formula 1-1 to Chemical Formula 1-4: 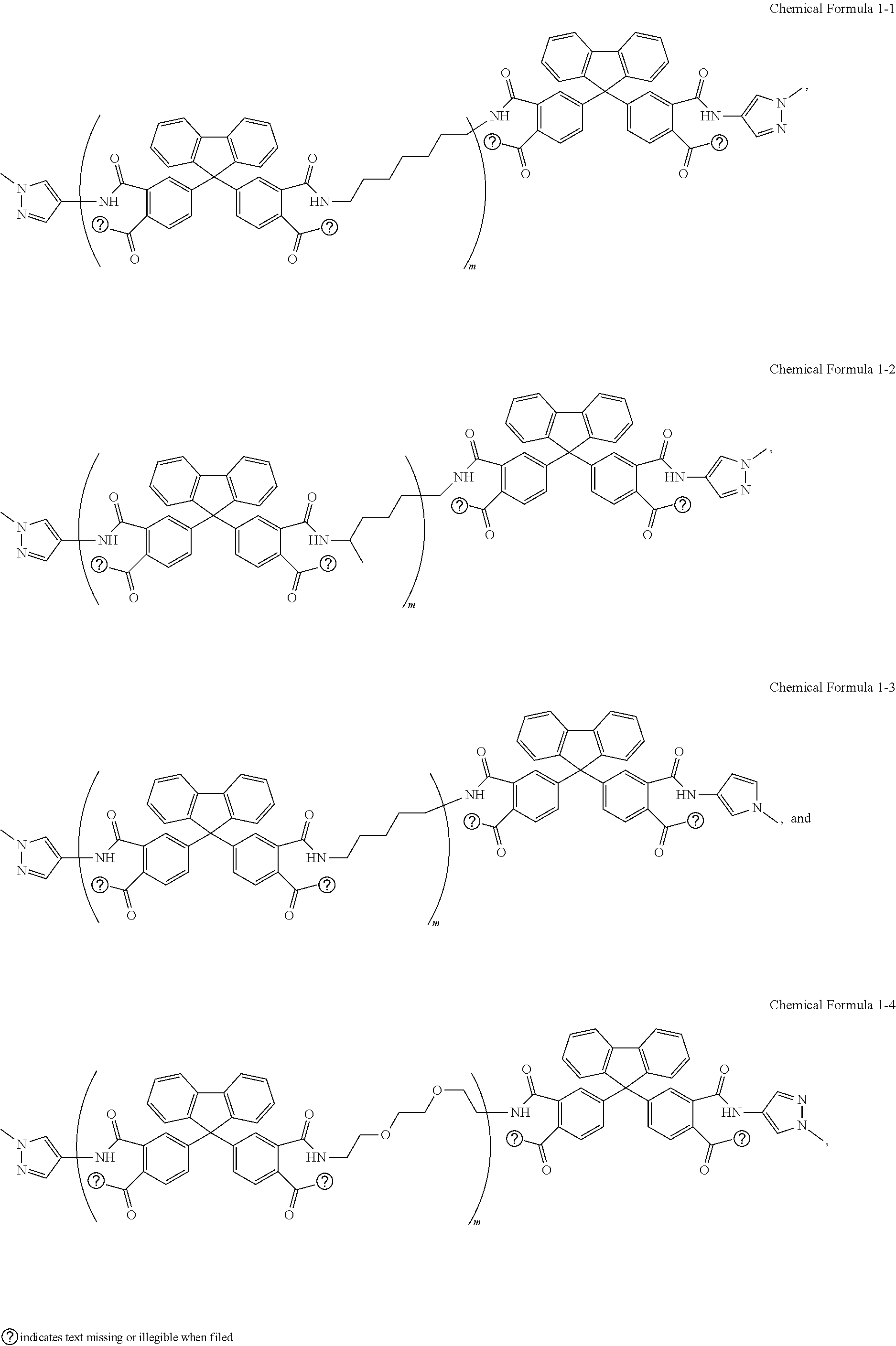
wherein, in Chemical Formula 1-1 to Chemical Formula 1-4,
R is represented by Chemical Formula 4, 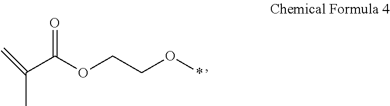 [SMILES: *OCCOC(=O)C(=C)C]
and
wherein in, Chemical Formula 4,
m is an integer of 1 to 100.

10. The photosensitive resin composition as claimed in claim 1, wherein:
the photosensitive resin composition comprises, based on 100 parts by weight of the polyimide resin,
5 parts by weight to 20 parts by weight of the photopolymerizable compound,
3 parts by weight to 10 parts by weight of the photopolymerization initiator, and
100 parts by weight to 500 parts by weight of the solvent.

11. The photosensitive resin composition as claimed in claim 1, wherein:
the photosensitive resin composition is a negative type photosensitive resin composition.

12. The photosensitive resin composition as claimed in claim 1, wherein:
a weight average molecular weight (Mw) of the polyimide resin represented by Chemical Formula 1 is in a range of 3,000 g/mol to 300,000 g/mol.

13. The photosensitive resin composition as claimed in claim 1, wherein:
the photopolymerization initiator comprises at least one selected from among an acetophenone-based compound, a benzophenone-based compound, a thioxanthone-based compound, a benzoin-based compound, a triazine-based compound, an oxime-based compound, and combinations thereof.

14. The photosensitive resin composition as claimed in claim 13, wherein:
the photopolymerization initiator further comprises at least one selected from among a carbazole-based compound, a diketone-based compound, a sulfonium borate-based compound, a diazo-based compound, an imidazole-based compound, a biimidazole-based compound, a fluorene-based compound, and combinations thereof.

15. The photosensitive resin composition as claimed in claim 1, further comprising at least one selected from among a photosensitizer, a radical scavenger, a silane-based coupling agent, an organic acid, and combinations thereof.

16. The photosensitive resin composition as claimed in claim 15, further comprising at least one other additive selected from among an antioxidant, a stabilizer, and combinations thereof.

17. A photosensitive resin layer manufactured utilizing the photosensitive resin composition as claimed in claim 1.

18. The photosensitive resin layer as claimed in claim 17, wherein:
the photosensitive resin layer is a semiconductor redistribution layer insulation layer.

19. A semiconductor device comprising the photosensitive resin layer as claimed in claim 17.

20. A method of manufacturing,
wherein the method is a method of manufacturing the photosensitive resin layer as claimed in claim 17,
the method comprising:
coating a photosensitive resin composition onto a substrate to form a coated layer;
heating the coated layer to remove a solvent and form a photosensitive resin film;
exposing the photosensitive resin film to actinic radiation through a mask to form a latent pattern;
developing the exposed film to remove unexposed portions and form a patterned photosensitive resin layer; and
post-processing the patterned photosensitive resin layer by heating.
